(19) United States
(12) Patent Application Publication
(10) Pub. No.: US 2014/0292203 A1
(43) Pub. Date: Oct. 2, 2014

(54) SYSTEM FOR APPAREL-RELATED AND OTHER ILLUMINATION

(71) Applicants: Lisa Ackerman, Boca Raton, FL (US); Brandon Ackerman, Boca Raton, FL (US)

(72) Inventors: Lisa Ackerman, Boca Raton, FL (US); Brandon Ackerman, Boca Raton, FL (US)

(21) Appl. No.: 14/229,330

(22) Filed: Mar. 28, 2014

Related U.S. Application Data
(63) Continuation-in-part of application No. 13/151,241, filed on Jun. 1, 2011, now abandoned.

(51) Int. Cl. H05B 37/02; H05B 33/08

(52) U.S. Cl. CPC H05B 37/0236; H05B 33/08
USPC 315/129; 315/307

(57) ABSTRACT

A system for apparel-related and other illumination includes an electro-luminance portion defining a graphic image having regions of differing optical transmissibility, the electro-luminance portion further configured to removably join to a back surface of a garment or pendant related to the graphic image; a housing configured to removably join to a back side of the electro-luminance portion; and a processor contained within the housing, the processor configured to control functions of the electro-luminance portion, the processor including elements for controlling a level of luminosity of the electro-luminance portion in correlation to changes in levels of ambient sound.

### REFERENCE TO RELATED APPLICATION

This application is a continuation-in-part of application Ser. No. 13/151,241, filed Jun. 1, 2011, and the same is incorporated herein in its entirety.

### BACKGROUND OF THE INVENTION

A. Field of the Invention

The invention generally relates to luminance associated with apparel. More particularly, the invention relates to a self-contained electro-luminance system for presentation of illuminated image responsive to ambient levels of sounds. Selectable Illumination of apparel provides consumers with opportunities for displaying highly visible and colorful images responsive to varying audio and RF ambient conditions.

B. Prior Art

The prior art is reflected in such patent as U.S. Pat. No. 6,116,745 (2000) to Yei, entitled Garments With An Electro Luminescent Circuit. The teaching of Yei is essentially that of sewing or otherwise attaching a label having an electro-luminescent (“EL”) display, however absent the many variables such an ambient audio and external RF signals to which the system of the present invention circuit is responsive, including variations in the nature of the display itself as is taught in the present invention.

Related art appears in U.S. Pat. No. 7,789,520 (2010) to Konig et al, entitled EL Communication System Between Articles Of Apparel And The Like. Koenig relates primarily to use EL with trademarks, logos or characters upon an article of apparel together with the ability to communicate with the apparel using a peer-to-peer network. The various EL effects of the display of Koenig derive from its communication system, as opposed to ambient variables as are set forth herein in respect to the present invention.

EL systems have been used in safety related applications, as in vests used by outdoor workers and first responders. Such art is reflected in U.S. Pat. No. 7,690,040 (2010) to Galoob et al. Similar art is reflected in U.S. Patent Application Publication 2004/00477146 (2004) to Galoob et al, entitled Safety Apparel And Signage with LED Display.

It is also known to use EL wires to display edges of articles of apparel, such as a bikini bottom or thong, this as is reflected in United States Patent Application No. 2006/0039165 (2006) to Harris et al, entitled Illuminated Apparel And Other Articles.

A system having removable EL panels, however without the many functions of the present invention including audio sensitivity, as is set forth herein, is taught in U.S. Patent Application Publication 20110025195 (2011) to Govender, entitled Clothing With Removable EL Panels.

### SUMMARY OF THE INVENTION

A system for apparel-related and other illumination comprises (a) an electro-luminance portion defining a graphic image having regions of differing optical transmissibility, said electro-luminance portion further configured to removably join to a back surface of a garment or pendant related to said graphic image (b) a housing configured to removably join to a back side of said electro-luminance portion; and (c) a processor contained within said housing, said processor configured to control functions of said electro-luminance portion, said processor including means for controlling a level of luminosity of said electro-luminance portion in correlation to changes in levels of ambient sound.

It is an object of the invention to provide a system for apparel-related and other illumination in which the illuminated display or graphic thereof includes regions of differing optical transmissibility and in which the micro-processor of the system includes means for controlling the level of luminosity of the display in correlation to change the levels of ambient sound.

It is another object to provide a system of the above type which includes means for providing a program sequence of EL photons directed, if desired, only to selectable regions of graphic image or portion of the system.

It is still another object to provide a means for facilitating enhanced photon density of electro-luminance photons directed to substantially transparent regions of the illuminated graphic image.

It is a further object of the invention to provide a system of the above type which includes, in the graphic image, transparent, translucent and/or opaque portions thereof.

It is another object to provide a system of the above type which includes pre-a programmed ROM responsive to the amplitude of ambient audio to initiate a sequence of photon intensities upon selectable regions of the graphic image or the entire image.

It is a further object of the invention to provide a processor operable to change the presentation displayed upon the EL portion responsive to locations, changes of location and rate changes of location determined by processed GPS information.

The above and yet other objects and advantages of the present invention will become apparent from the hereinafter Brief Description of the Drawings, Detailed Description of the Invention, and Claims appended herewith.

### BRIEF DESCRIPTION OF THE DRAWINGS

FIG. 1 illustrates an example electro-luminance system, in accordance with an embodiment of the present invention;

FIG. 2 illustrates an example shirt with reference to FIG. 1, with the electro-luminance device removed.

FIG. 3 illustrates an example process for attachment and removal of an electro-luminance device to or from a shirt, in accordance with the present invention;

FIG. 4 presents an example right-side view as described with reference to FIG. 1 for attachment and removal of the electro-luminance device to/from the shirt.

FIG. 5 presents an example left-side view as described for attachment and removal of the electro-luminance device to or from the shirt, in accordance with the present invention;

FIG. 6 presents an example bottom view as described for a containment device.

FIG. 7 illustrates an example containment portion detached from a luminance generating portion with a cable connected between the containment portion and the luminance generating portion, in accordance with the present invention;

FIG. 8 illustrates an example for connecting a source of power for powering electronic equipment located internal to a containment portion and/or for charging a battery located internal to containment portion.

FIG. 9 is a block diagram of a system for controlling the operation of a luminance generation portion, in accordance with an embodiment of the present invention;

FIG. 10 presents an example photograph of a top view of the control system.

FIG. 11 presents an example photograph of a bottom view of the control system, in accordance with the present invention;

FIG. 12 presents an example photograph of elements of the containment portion.

FIG. 13 presents an example photograph of the front view of the electro-luminance device.

FIG. 14 presents an example photograph of the back of the electro-luminance device.

FIG. 15 illustrates an example program for operation of the electro-luminance system in accordance with the present invention.

FIG. 16 illustrates a mobile device that, when appropriately configured or designed, may be used with the present invention may be used.

### DETAILED DESCRIPTION OF THE INVENTION

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings herein, recognize a multiplicity of alternate or suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Although the Claims have been formulated in this Application to particular combinations of features, it should be understood that the scope of the disclosure of the present invention also includes any novel feature or any novel combination of features disclosed herein either explicitly or implicitly described or any generalization thereof, whether or not it related to the same invention as presently claimed and whether or not it addresses any or all of the same technical problems as does the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

“Software” may refer to prescribed rules to operate a computer. Examples of software may include: code segments in one or more computer-readable languages; graphical and or/textual instructions; applets; pre-compiled code; interpreted code; compiled code; and computer programs.

An algorithm is here and generally considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A first embodiment of the present invention is described which provides means and methods for providing an electro-luminance system. An electro-luminance portion may be incorporated into an article of clothing for presentation of illumination. The electro-luminance portion may be attached to article of clothing such that it may be removed from article of clothing to perform laundering of an article of clothing without damaging the electro-luminance portion.

Non-limiting examples for control elements of electro-luminance portion include a power switch, indicator device, power connection, sensitivity adjustment and microphone. The electro-luminance portion may be powered by self-contained rechargeable battery. Rechargeable battery may be charged via a connection to an external power source. Control and configuration of the electro-luminance system also may be performed via receipt of audible commands and defined ambient audio environments.

In other embodiments of the present invention, a method and means for providing control of the electro-luminance system via wireless means is described includes an antenna and transceiver for receiving and transmitting information. Non-limiting examples for sources of information received by electro-luminance system include an optional Global Positioning System (GPS) and external wireless control modules. RF information received wirelessly may operate to control and configure the electro-luminance system.

Theory of Electro Luminance

An electroluminescent element is, in effect, a dielectric capactator in which the EL material, generally referred to as the emitting layer is disposed between respective upper and lower surfaces, termed transparent electrodes. Across the transparent electrodes is applied a voltage. An increase of voltage in one direction causes the phosphors within the emitting layer to imitate a current flow across the emitting layer. In turn the energy of the current causes an emission of photons as a result of changes in the electro-quantum, chemistry of the phosphors of the emitting layer.

Each electrode is formed of a conducting material but one that is so thin such that the light is not able to pass therethrough and therefrom light is emitted from the emitting layer through one electrode only. EL elements may be formed in many geometries ranging from thin wires, co-axial wires, and flat panels. Such elements will only operate in response to alternating (AC) voltage, meaning they will not operate on direct current unless the direct current is rectified.

EL elements may be purchased in large sheets and then cut into shape or shapes that may be desired for a particular application. Further, the color produced by an EL panel can be altered by changing the frequency of a voltage supplied to and/or the amplitude of the voltage. EL elements are also highly energy-efficient in that they consume only about 16 milliwatts per square inch of material, and the brightness of contemporary EL panels is in the range of 15 to 35 foot Lamberts, while the thickness of state-of-the-art EL panels is in the range of about ⅓ of a millimeter. Also, they do not generate heat, so that no special venting or insulation for their use is required. EL panels are also extremely durable and typically can be twisted, flexed, and coiled as well as folded up to an angle of 45 degrees. As such, the possible optical effects in the use of EL panels, laminates or the like are nearly unlimited.

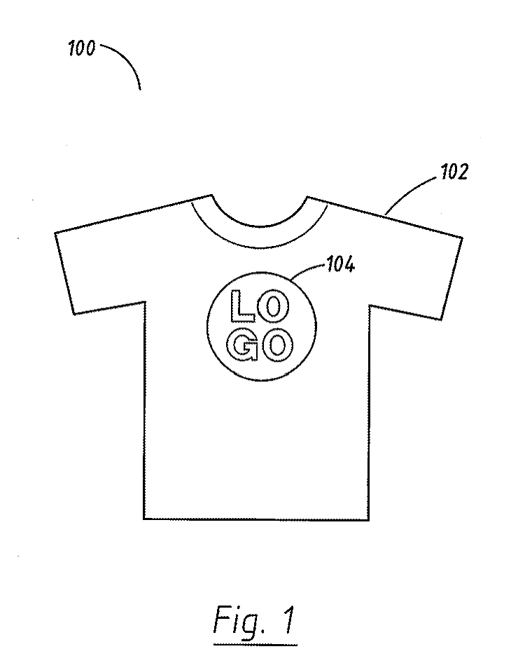

FIG. 1 illustrates an exemplary electro-luminance system, in accordance with the present invention.

An electro-luminance system 100 includes a shirt 102 and an electro-luminance device 104.

The article of clothing presented for this example is a shirt; however, any known article of clothing may be used. Non-limiting examples for articles of clothing include shirts, pants, coats, hats, socks, or pendants.

Shirt 102 functions as apparel for wearing. Electro-luminance device 104 operates to present an illuminated or partially illuminated image and/or pattern for viewing which may be externally actuated by audio waves or RF signals, as is set for the below.

Electro-luminance device 104 attaches to shirt 102 and may be removed from shirt 102. As a non-limiting example, electro-luminance portion 104 may be removed from shirt 102 in order to laundry shirt 102. Furthermore, removal of electro-luminance device 104 while laundering shirt 102 prevents damage to the electro-luminance device 104 during the laundry process.

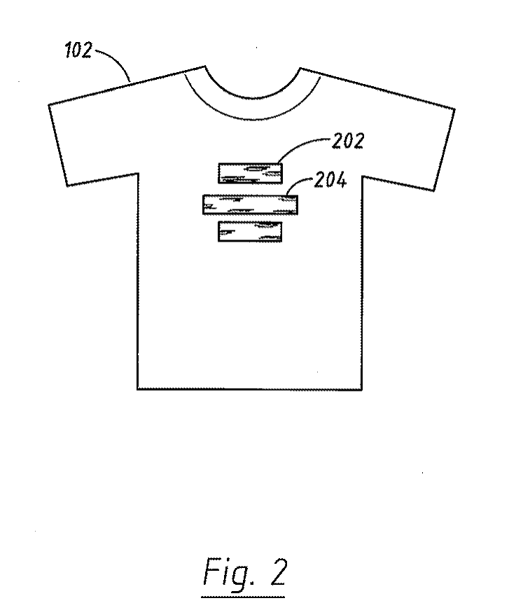

FIG. 2 illustrates example shirt as discussed with reference to FIG. 1, with the electro-luminance device removed, in accordance with an embodiment of the present invention. Shirt 102 includes a multiplicity of fastening devices with a sampling denoted as a fastening device 202 and a fastening device 204. Fastening devices 202 and 204 operate to fasten an electro-luminance graphic to shirt 102. Non-limiting examples for fastening device 202 and fastening device 204 include hook and loop means, i.e., VELCRO. For example, if fastening device 202 is a hook device, then a loop device is attached to the electro-luminance device and vice-versa. Non-limiting examples for methods of attaching fastening device 202 and fastening device 204 to shirt 102 include, sewing, taping and gluing.

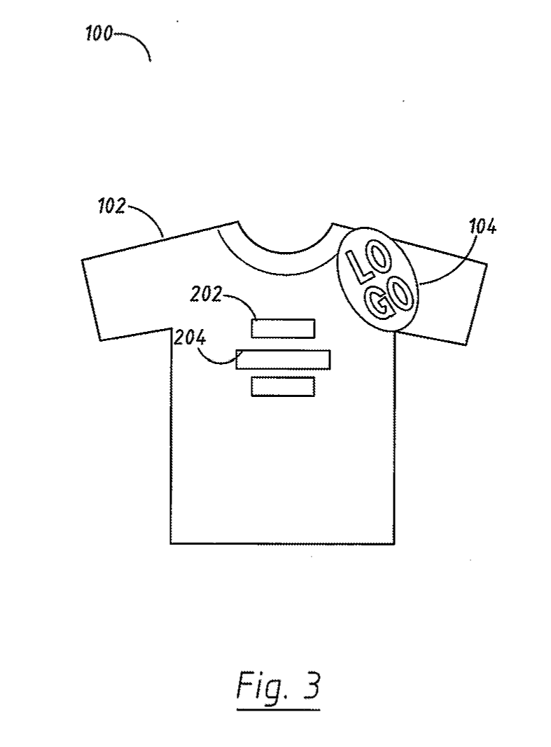

FIG. 3 illustrates an example process for attachment and removal of an electro-luminance device to or from a shirt. Electro-luminance portion 104, which may take the form of a graphic, may be attached to shirt 102 via alignment of the fastening devices associated with shirt 102 to the fastening devices associated with electro-luminance portion 104 having regions of differing optical transmissibility. Portion 104 may be removed from shirt 102 via application of sufficient force for removal.

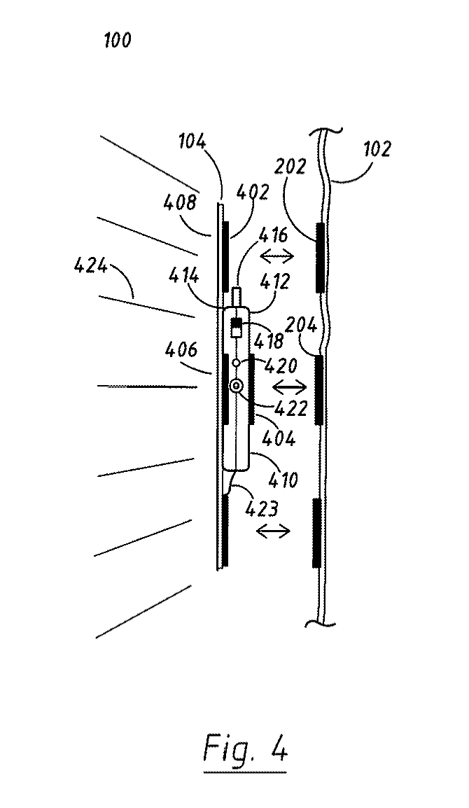

FIG. 4 presents a right-side view showing the attachment and removal of the electro-luminance portion to or from the shirt. Electro-luminance portion 104 (FIG. 1) includes a first-fastening device 402, a second-fastening device 404, a third-fastening device 406, a luminance generating surface 408, a lower containment portion 410, a top containment portion 412, a bottom containment portion 414, a loop element 416, a switch 418, an indicator 420, a power connection 422 and a cable 423. In FIG. 4, fastening device 402 operates to fasten graphic portion 104 to shirt 102 via connection to fastening device 202. Fastening device 404 operates to fasten electro-luminance device 104 to shirt 102 via connection to second fastening device 204. As a non-limiting example, fastening devices 402 and 404 may be secured via hook and loop means. Fastening device 406 operates to fasten a containment portion 410 EL electrode to EL electrode or luminance generating surface 408. Non-limiting examples for fastening device 406 include hook, loop, glue and tape.

Containment portion of housing 410 operates to contain and protect electronic equipment located internally. Top containment portion 412 and bottom containment portion 414 operate to fasten together to form the entire containment portion 410. Loop 416 provides a mechanism for mechanically removing containment portion 410 from luminance generating portion 408. Switch 418 enables or disables the operation of electronic equipment located internally to containment portion 410. Indicator portion 420 operates to provide a visual indicator for the operation of the electronic equipment located within containment portion 410. Information communicated via indicator portion 420 include power on, power off, operational and stand-by-mode. Power connection 422 provides a means for connecting a power supply to the electronic equipment located internally to containment portion 410 for providing power and/or charging a battery. Cable 423 enables communication of information from the electronic equipment, located internal to containment portion or housing 410, to EL electrode or generating portion 408. A multiplicity of illumination beams 424 emanate from luminance generating elements of portion 408. Photons of Illumination beams 424 may be of any color, variation of color, pattern or intensity.

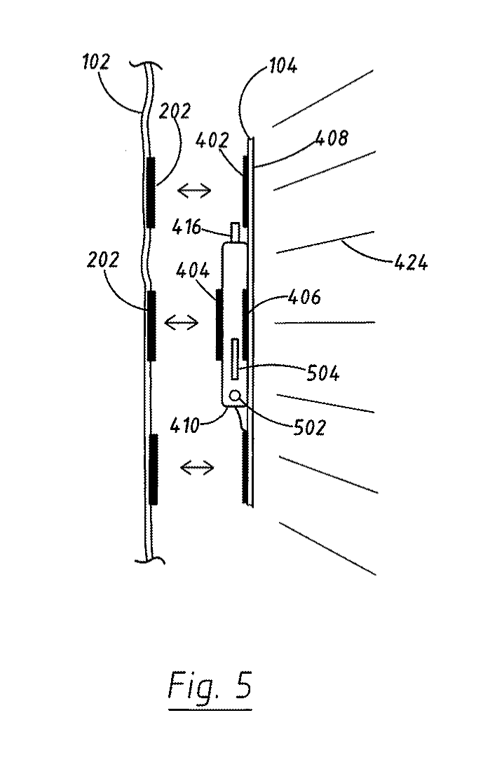

FIG. 5 presents an example left-side view for attachment and removal of the electro-luminance graphic portion to or from the shirt.

Aspects of FIG. 5 in common with FIG. 4 will not be described for FIG. 5. For elements of FIG. 5 in common with FIG. 4, the reader may refer to the discussion with reference to FIG. 4.

Containment portion 410 or housing includes a microphone 502 and an adjustment mechanism 504.

Microphone 502 operates to receive audio waves or RF signals for configuring the operation of the electronic equipment located in the containment portion 410. Adjustment mechanism 504 operates to adjust the operation of the electronic equipment located internally to containment portion 410. Examples for the function of adjustment mechanism 504 include ambient audio sensitivity and illumination intensity. In one embodiment, adjustment mechanism 504 may operate to control the sensitivity of microphone 502. In another embodiment, adjustment mechanism 504 may operate to control the intensity of illumination beam 424. In another embodiment, operation of adjustment mechanism 504 may be selected by verbal command or wireless command.

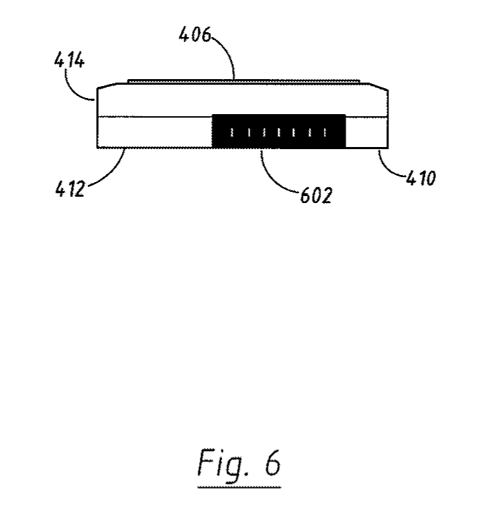

FIG. 6 presents an example bottom view as described for a containment device, in accordance with the present invention. Elements of FIG. 6 in common with FIGS. 4-5 will not be described for FIG. 6. For elements of FIG. 6 in common with FIGS. 4-5, the reader may refer to the discussion of FIGS. 4-5. Containment portion 410 includes a connector 602. Connector 602 enables communication of information for the control of luminance generating portion 408 by the electronic equipment located internal to containment portion 410.

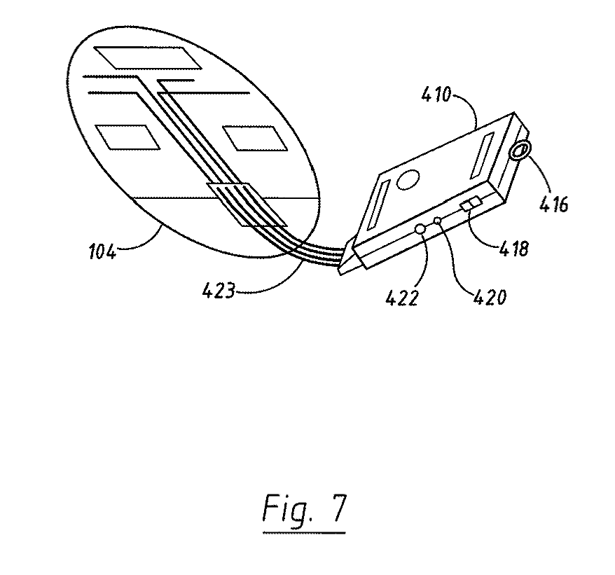

FIG. 7 illustrates an example for the containment portion 410 detached from the luminance generating portion 408 with a cable 423 connected between the containment portion or housing and the luminance generating portion, in accordance with an embodiment of the present invention. Cable 423 connects the electronic equipment located internally to containment portion 410 to electro-luminance portion 104. One end of cable 423 couples with connector 602. See FIG. 6.

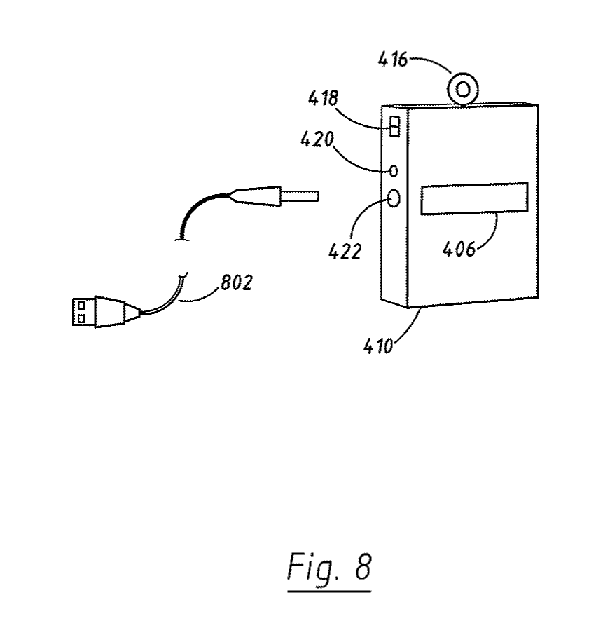

FIG. 8 illustrates an example for connecting a source of power for powering electronic equipment located internal to a housing 410 and/or for charging a battery located internal to it. A cable 802 connects to power connection 422 and to a source of power (not shown). Examples for sources of power include a Universal Serial Bus (USB), power supply and a battery.

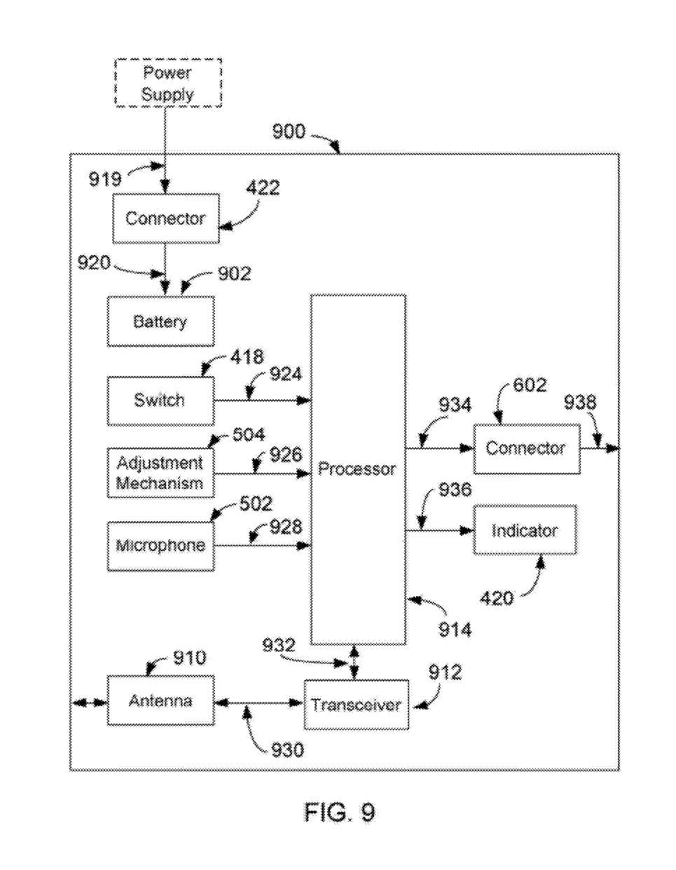

FIG. 9 illustrates an example control portion for controlling the operation of the luminance generation portion. A control portion 900 includes switch 418, indicator portion 420, connector 602, adjustment mechanism 504, microphone 502, a battery 902, an antenna 910, a transceiver 912 and a processor 914. Elements of FIG. 9 in common with FIGS. 4-8 will not be described for FIG. 9. That is, the reader may refer to the discussion with reference to FIGS. 4-8.

Battery 902 operates to provide power for electronic components associated with control portion 900 and for electronic components located externally to control portion 900. As a non-limiting example, battery 902 may be lithium. Antenna 910 operates to receive and transmit information wirelessly to externally located electronic equipment, and includes the audio function of microphone 502. Non-limiting examples of devices which may be communicated with via antenna 910 may include GPS and wireless devices. Transceiver 912 operates to receive and transmit information wirelessly to externally located electronic equipment. Processor 914 operates to programmatically control the operation of control portion 900 and electronic equipment located external to control portion 900, as does audio microphone 502.

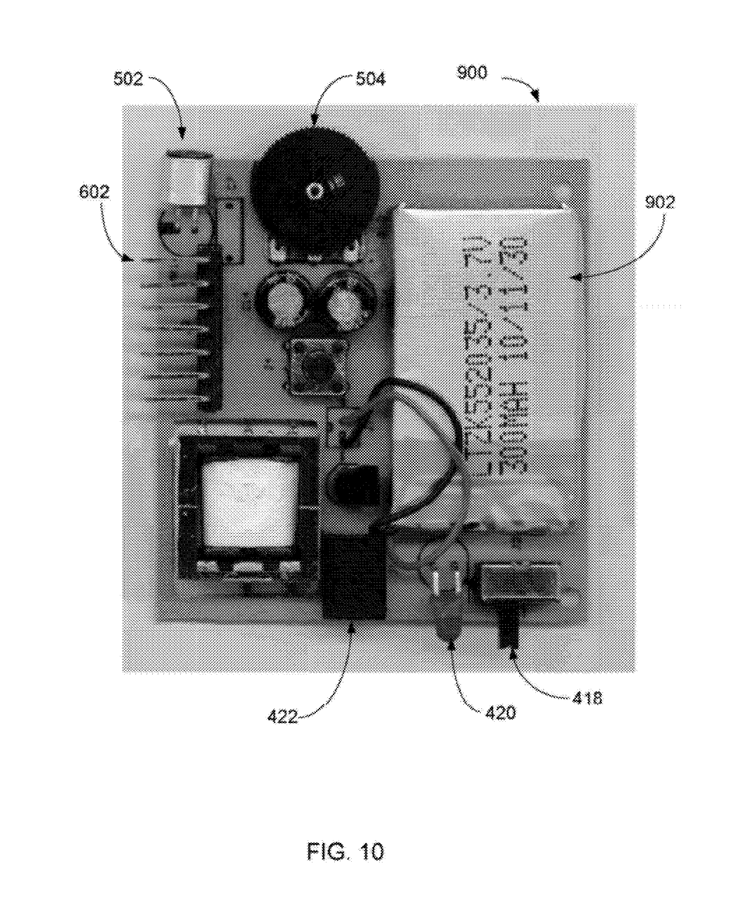

Power connection 422 receives power from a power supply located external to control portion 900 via a signal 919. Battery 902 receives power from power connection 422 (see FIG. 10) for charging battery 902 via a signal 920. Battery 902 operates to provide power to electronic components associated with control portion 900 and for externally located electronic equipment. Processor 914 receives information via a signal 924 from switch 418. Processor 914 receives control information from adjustment mechanism 504 via a signal 926. Processor 914 receives ambient audio information from microphone 502 via a signal 928. Processor 914 communicates bi-directionally with transceiver 912 via a signal 932. Antenna 910 communicates bi-directionally with transceiver 912 via a signal 930. Indicator portion 420 receives information from processor 914 via a signal 936. Connector 602 receives information from processor 914 via a signal 934. Connector 602 communicates information external to control portion 900 via a signal 938.

Audio information is received via microphone 502 for controlling the operation of control portion 900 in regard to current provided to luminescent generating electrode or surface 408. For example, a specific clapping sequence, other sound or sound intensity may represent a signal to disable or enable illumination. Sensitivity for such received information may be controlled via adjustment mechanism 504. For example, if background noise received via microphone 502 causes an error in enabling or disabling illumination, the sensitivity associated with microphone 502 may be adjusted to prevent miscellaneous background noise from enabling or disabling illumination.

Location information may be received via antenna 910 and transceiver 912 via a GPS. Received location or audio information may be used for enabling, disabling or adjusting the intensity or color of luminance. For example, for a user traveling in one direction, a particular color of luminance may be projected and for a user traveling in another direction, a different color of luminance may be projected by photons 424. Furthermore, enablement or disablement of luminance may be controlled depending upon the location of a user.

Apart from audio, control of control portion 900 may be wirelessly controlled via an external wireless control device. For example, a device similar to devices used for alarming and de-alarming automobiles may be used for configuring the operation of control portion 900.

FIG. 10 presents an example photograph of a top view of the control portion, in accordance with an embodiment of the present invention. Elements of control portion 900 presented in the photograph include switch 418, indicator portion 420, power connection 422, microphone 502, adjustment mechanism 504 and battery 902.

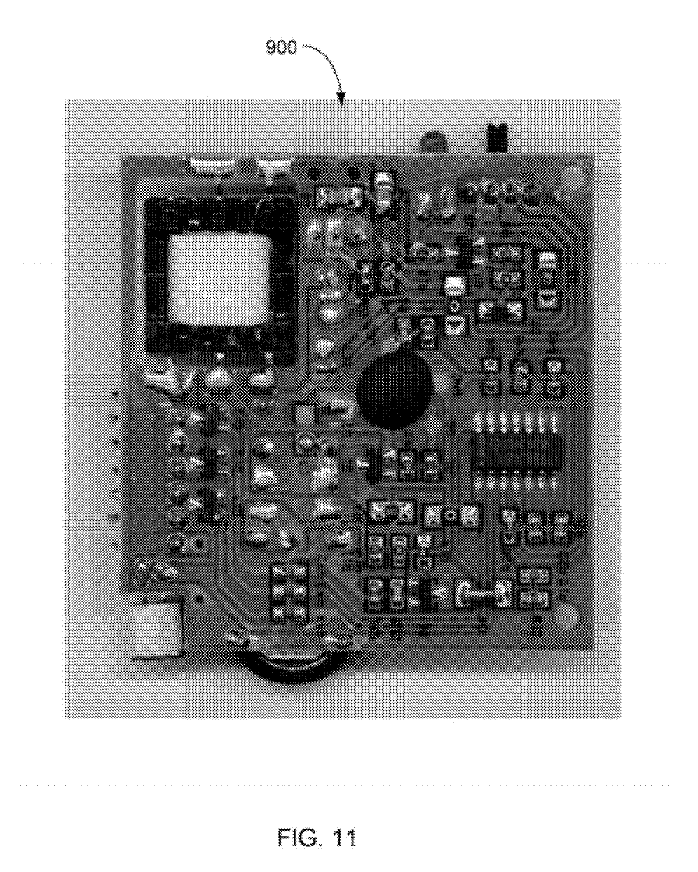

FIG. 11 presents an example photograph for a bottom view the circuitry of the control portion of FIG. 10.

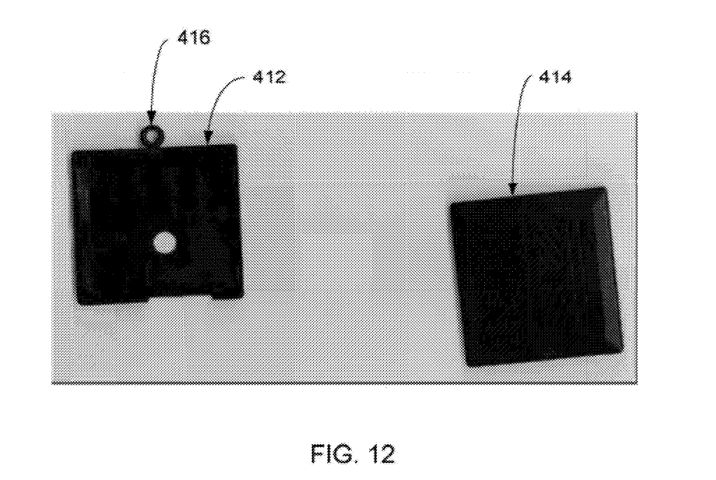

FIG. 12 presents an example photograph for elements of the housing or containment portion. Elements of containment portion 410 presented in the photograph include top containment portion 412, bottom containment portion 414 and loop 416.

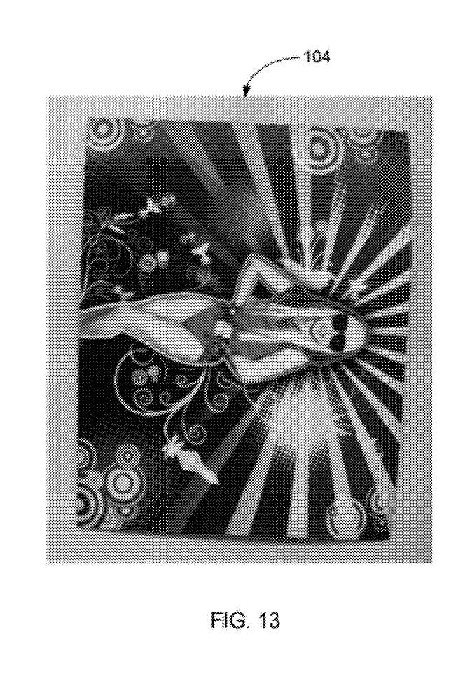

FIG. 13 presents an example photograph for a first view of the electro-luminance device as described with reference to FIG. 1. As illustrated, electro-luminance portion 104 presents an illuminated image for viewing.

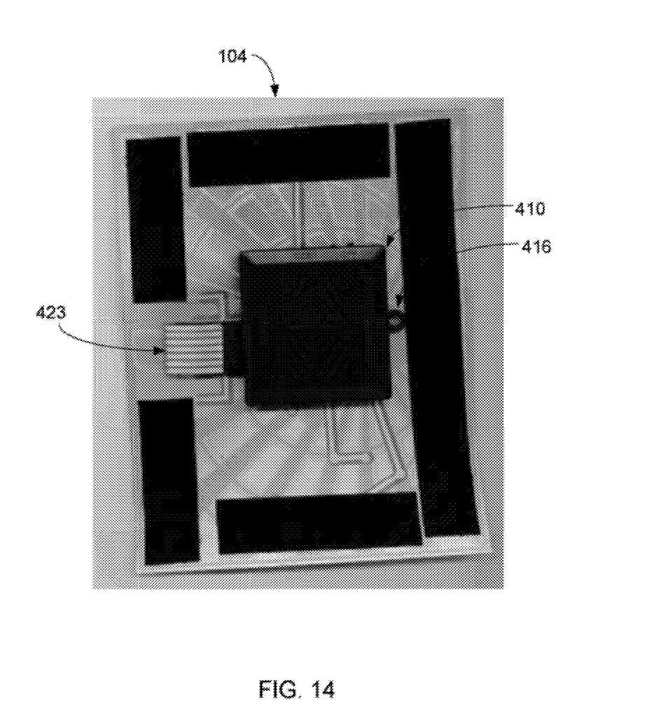

FIG. 14 presents a photograph of a rear view of the electro-luminance portion as described above. Elements of the electro-luminance graphic presented in the photograph include housing 410, loop 416 and cable 423 in which the graphics defined by regions 426, 428 and 430 may be of differing optical transmissibility, thus enlarging the display options of the system responsive to both audio and RF inputs.

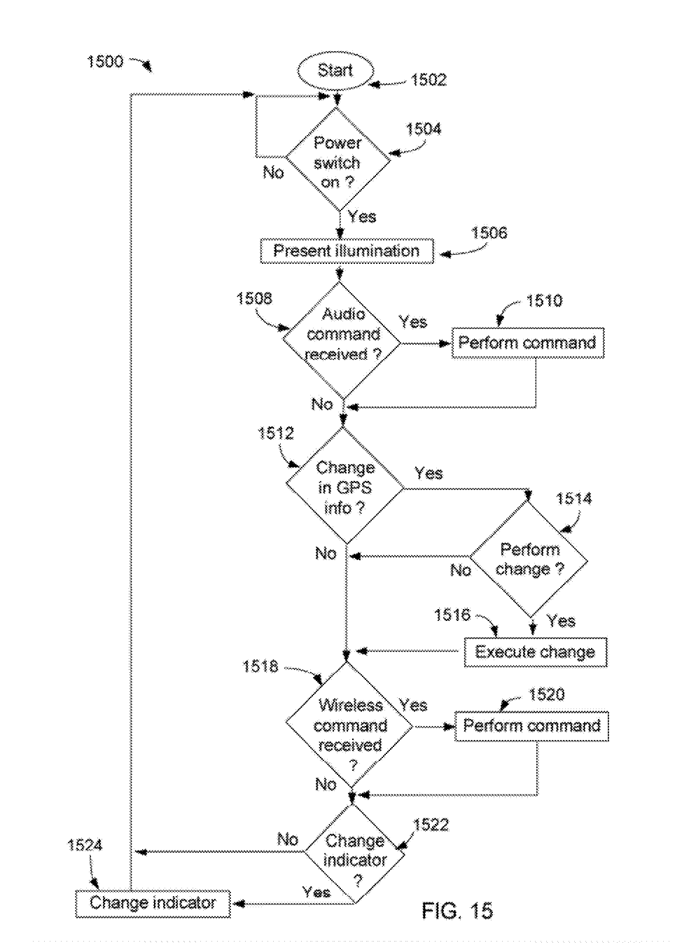

FIG. 15 illustrates an example method of operation of the electro-luminance system, herein, and presents a flow chart 1500 with a process initiating at a step 1502. In a step 1504, is determined as to whether the power switch 418 is configured for operation. For a determination of the power switch not figured for operation in step 1504, execution of process remains in step 1504. For a determination of power switch configured for operation in step 1504, illumination is presented via electro-luminance system in a step 1506.

In a step 1508, a determination for receipt of an audio command, waveform or particular audio intensity may be received. Receipt of the audio command may be performed by a user and received by microphone 502. A determination for receipt of an audio command is performed at step 1510. Non-limiting examples of audio commands performed include power-off, power-on, increased intensity, decreased intensity, modification of color and/or modification presentation of an illumination and sequence of illumination of the graphic of FIG. 13 and parts thereof including spatial sequence or audio intensity waveforms.

A determination of a change associated with GPS information may be performed in a step 1512. Information associated with a GPS may be received by antenna 910 and transceiver 912. For a determination of a change associated with GPS information in step 1512, a determination may be performed in a step 1514 as to whether a modification for the configuration of the electro-luminance system is to be executed. For a determination of executing a command associated with GPS information in step 1514, a command may be performed in a step 1516. Non-limiting examples of commands performed include configuration of electro-luminance system 100 based upon the location, velocity or acceleration of a user associated with an electro-luminance system. For example, in response to a user associated with an electro-luminance system changing location, direction, velocity or acceleration, the presentation displayed by electro-luminance system may change. A determination for receipt of a wireless command may be performed in a step 1518. Information associated with a wireless command may be received by antenna 910 and transceiver 912. For a determination of receiving a wireless or RF command in step 1518, a received wireless command may be performed in a step 1520. Non-limiting examples of wireless commands performed include power-off, power-on, increased intensity, decreased intensity, modification of color and modification of presentation of illumination of the graphic of FIG. 13. Non-limiting examples of standards for performing wireless commands include Bluetooth, Wi-Fi and ambient audio level and patterns.

A determination for changing indicator 420 (see FIG. 4) may be performed in a step 1522. Non-limiting examples of conditions for changing the status of indicator include low battery power, battery charging initiated, battery charging completed, power-on and power-off. For a determination of modifying indicator in step 1522, indicator may be modified in a step 1524. For a determination of not modifying indicator in step 1522 or following modification of indicator in step 1524, execution of process transitions to step 1504.

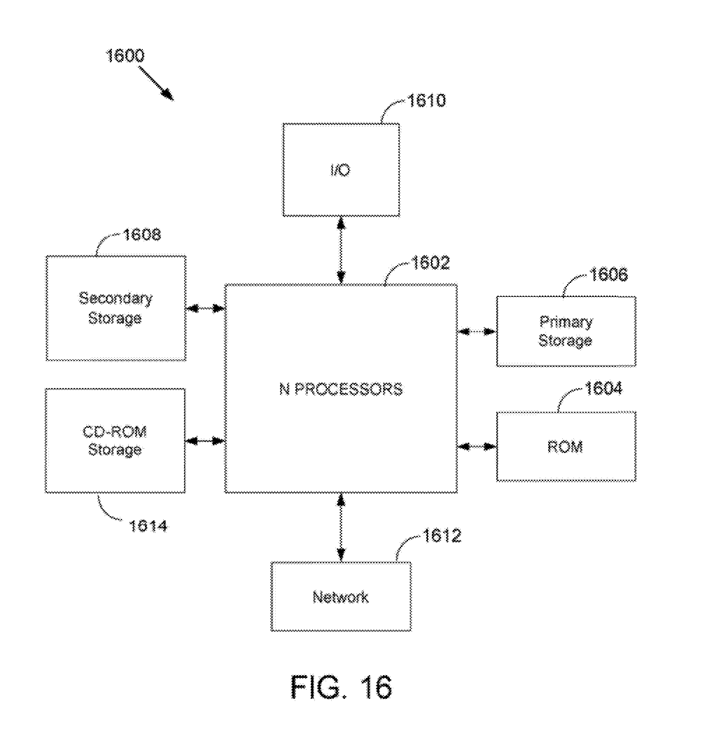

FIG. 16 illustrates a mobile device that, when appropriately configured or designed, may serve as a mobile device for which the present invention may be adapted.

A mobile device 1600 includes a quantity of processors 1602 (also referred to as central processing units, or CPUs) that may be coupled to storage devices including a primary storage 1606 (typically a random access memory, or RAM), a primary storage 1604 (typically a read only memory, or ROM). CPU 1602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 1604 acts to transfer data and instructions uni-directionally to the CPU and primary storage 1606 is used typically to transfer data and instructions in a bi-directional manner. The primary storage devices discussed previously may include any suitable computer-readable media such as those described above. A mass storage device 1608 may also be coupled bi-directionally to CPU 1602 and provides additional data storage capacity and may include any of the computer-readable media described above. Mass storage device 1608 may be used to store programs, data and the like and is typically a secondary storage medium such as a hard disk. It will be appreciated that the information retained within mass storage device 1608, may, in appropriate cases, be incorporated in standard fashion as part of primary storage 1606 as virtual memory. A specific mass storage device such as a CD-ROM 1614 may also pass data uni-directionally to the CPU.

CPU 1602 may also be coupled to an interface 1610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1602 optionally may be coupled to an external device such as a database or a computer or telecommunications or internet network using an external connection shown generally as a network 1612, which may be implemented as a hardwired or wireless communications link using suitable conventional technologies. With such a connection, the CPU might receive information from the network, or might output information to the network in the course of performing the steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

Having fully described at least one embodiment of the present invention, other equivalent methods of electro-luminance systems according to the invention will be apparent to those skilled in the art. The invention has been described above by way of illustration, and the specific embodiments disclosed are not intended to limit the invention to the particular forms disclosed. For example, the particular implementation of the luminance generating portion may vary depending upon the particular type of image used and signals received. The systems described in the foregoing were directed to apparel implementations; however, similar techniques such as automotive, cycling or pendant-related implementations of the present invention are contemplated within the scope of the invention. The invention thus encompasses all modifications, equivalents, and alternatives falling within the spirit, letter and scope of the following claims.

1. A system for apparel-related and other illumination, comprising:
(a) an electro-luminance portion defining a graphic image having regions of differing optical transmissibility, said electro-luminance portion further configured to removably join to a back surface of a garment or pendant related to said graphic image;
(b) a housing configured to removably join to a back side of said electro-luminance portion; and
(c) a processor contained within said housing, said processor configured to control functions of said electro-luminance portion, including means for actuating a level of luminosity of said electro-luminance portion in correlation to changes in levels of ambient sound.

1. The system as recited in claim 1, said processor further comprising:
means for providing a programmed sequence of electro-luminance photons thereof directed to regions of said graphic image.

2. The system as recited in claim 1, further comprising means for enabling enhanced photon density of said electro-luminance portion directed to substantially transparent regions of said graphic image.

3. The system as recited in claim 3, further comprising:
means for selectable amplification of effects of said electro-luminance portion upon translucent regions of said graphic image.

4. The system as recited in claim 2, further comprising:
means for selectable amplification of effects of said electro-luminance portion upon translucent regions of said graphic image.

5. The system as recited in claim 1, in which a function of said processor comprises:
a pre-programmed ROM responsive to an amplitude of ambient audio to initiate a sequence of electro-luminance portion intensities upon selectable regions of that side of said graphic image to which said processor is most proximal.

6. The system as recited in claim 6, in which programming of said ROM includes provision of selectable photon density to selectable opaque versus translucent regions of said graphic image.

7. The system as recited in claim 6, in which said RAM includes programming specific to a photonic release of different densities of light for one or more of each transparent, translucent or opaque region respectively.

8. The system as recited in claim 1, further comprising an adjustment mechanism operable to signal said processor to adjust a sensitivity of a microphone system.

9. The system as recited in claim 9, said adjustment mechanism further operable to signal said processor to adjust a photonic output of said electro-luminance portion.

10. The system as recited in claim 1, said processor operable to change a presentation displayed by said electro-luminance portion in response to a location determined from GPS information.

11. The system as recited in claim 11, said processor operable to change a presentation displayed by said electro-luminance portion in response to a change of location determined from said GPS information.

12. The system as recited in claim 12, said processor operable to change a presentation displayed by said electro-luminance portion in response to a rate of change of location determined from said GPS information.

13. The system as recited in claim 11, said processor operable to change a presentation displayed by said electro-luminance portion in response to a change in rate of change of location determined from said GPS information.

14. The system as recited in claim 1, further comprising an indicator joined to said housing for indicating a status of a rechargeable power source.

15. The system as recited in claim 15, further comprising:
a USB connection operable to charge said rechargeable power source.
